(19) United States
(12) Patent Application Publication
(10) Pub. No.: US 2024/0259370 A1
(43) Pub. Date: Aug. 1, 2024

(54) IDENTIFYING TYPES OF ENTITIES COMMUNICATING OVER A NETWORK

(71) Applicant: Edgio, Inc., Phoenix, AZ (US)

(72) Inventors: Li Yang, Sunnyvale, CA (US); Devender Singh, Westminster, CA (US)

(73) Assignee: Edgio, Inc., Phoenix, AZ (US)

(21) Appl. No.: 18/428,798

(22) Filed: Jan. 31, 2024

Related U.S. Application Data
(60) Provisional application No. 63/442,314, filed on Jan. 31, 2023.

(51) Int. Cl. H04L 9/40

(52) U.S. Cl. CPC H04L 63/0861; H04L 63/1425

(57) ABSTRACT

Described herein are various examples of techniques for server-side identification of an entity communicating over a network, which may in some embodiments include techniques for identifying entities communicating in a network based on a signature for the entity and/or behavior of the entity as determined or observed by one or more servers in the network. In some embodiments, server-side identification may include signature analysis, including collecting information regarding the entity from communications received at the server and/or received at an intermediary server that may perform caching functionality and using such information to determine a signature of the entity. In some embodiments, server-side identification can also include behavior analysis, including current behaviors and historical behaviors gathered in part from network traffic transmitted by the entity, such as traffic between the entity and other devices on the network, such as the server doing the behavior analysis, other servers, or other devices.

### CROSS REFERENCE TO RELATED APPLICATION

This application claims the benefit under 35 U.S.C. § 119(e) of U.S. Provisional Patent Application No. 63/442,314, filed Jan. 31, 2023, the entire contents of which are incorporated herein by reference.

### BACKGROUND

Content delivery networks (CDNs) allow for the widespread distribution of content, including images, videos, and large files to users. A typical CDN includes a plurality of distributed servers in various locations, each server hosting some or substantially all of the same content as any other server in the network. This architecture allows for low latency-high performance delivery of content by bringing the source of the content closer to the user.

### SUMMARY

In one embodiment, there is provided a method including: determining, at a server disposed in a content delivery network (CDN) and from one or more messages transmitted by an entity over the CDN, signature information and behavior information corresponding to the entity; determining a type of the entity at least in part by analyzing the signature information and behavior information corresponding to the entity; and outputting the type of the entity.

In some embodiments, there is provided a method, wherein the server includes an intermediary server included in a CDN point of presence (POP) that caches content available at an origin server to be provided by the intermediary server of the CDN POP to a client.

In additional embodiments, there is provided a method, wherein the signature information includes fingerprint-based features of the entity gathered during authentication of the entity.

In some embodiments, there is provided a method, wherein the fingerprint-based features of the entity include at least one of: user-agent (UA) information for the entity; JA3 fingerprinting information for the entity; cipher suite information for the entity; or security protocol information proposed by the entity.

In at least one embodiment, there is provided a method, wherein determining the signature information includes determining a proposed set of security protocols that the entity has proposed for securing of communications of the entity.

In some embodiments, there is provided a method, wherein: determining the behavior information corresponding to the entity includes determining a behavior exhibited by the entity in the one or more messages; and determining the type of the entity includes analyzing the behavior exhibited by the entity.

In at least one embodiment, there is provided a method, wherein: determining the type of the entity includes determining, based at least in part on analyzing the proposed set of security protocols, whether the entity communicating over the CDN is a nonhuman entity; and outputting the type of the entity includes outputting an indication of whether the entity has been determined to be a nonhuman entity.

In additional embodiments, there is provided a method, wherein determining at least one of the signature information or the behavior information includes analyzing log data corresponding to communications transmitted by the entity over the CDN, the log data including at least one of: Web Application Firewall (WAF) logs; CDN logs; or bot logs.

In some embodiments, there is provided a method, wherein analyzing the signature information and behavior information includes extracting one or more features from the one or more messages transmitted by the entity over the CDN, the one or more features including at least one of: a Reverse Domain Name System (rDNS) result; an Autonomous System Number (ASN) Mapping; a Forward Domain Name System (DNS) result; one or more Web Application Firewall (WAF) Alerts; or one or more bot alerts.

In at least one embodiments, there is provided a method, wherein determining the type of the entity further includes applying a predetermined set of rules to the one or more features to generate an entity classification.

In additional embodiments, there is provided a method, wherein: the method further includes: determining, from the one or more messages transmitted by the entity over the CDN, Internet Protocol (IP) domain information corresponding to the entity; and determining whether the entity communicating over the CDN is a legitimate known entity by at least in part matching the IP domain information corresponding to the entity; and outputting the type of the entity includes outputting whether the entity is the legitimate known entity.

In some embodiments, there is provided a method, wherein determining the type of the entity includes determining whether the entity communicating over the CDN is a malicious nonhuman entity at least in part by using a trained machine learning model that leverages the signature information and behavior information corresponding to the entity to generate an entity classification prediction; and outputting the type of the entity further includes outputting an indication of whether the entity is a malicious nonhuman entity.

In additional embodiments, there is provided a method, wherein determining whether the entity communicating over the CDN is a malicious nonhuman entity at least in part by using the trained machine learning model that leverages the signature information and behavior information corresponding to the entity to generate the entity classification prediction includes processing extracted features via the trained machine learning model trained to generate the entity classification prediction.

In some embodiments, there is provided a method, wherein: the entity classification prediction includes a classification of the entity with a confidence value; and outputting the type of the entity further includes outputting the confidence value.

In one embodiment, there is provided a system including: at least one processor; and at least one computer-readable medium having encoded thereon executable instructions that, when executed by the at least one processor, cause the at least one processor to carry out a method, the method including: determining, at a server disposed in a content delivery network (CDN) and from one or more messages transmitted by an entity over the CDN, signature information and behavior information corresponding to the entity; determining a type of the entity at least in part by analyzing the signature information and behavior information corresponding to the entity; and outputting the type of the entity.

In some embodiments, there is provided a system, wherein the signature information includes fingerprint-based features of the entity gathered during authentication of the entity.

In additional embodiments, there is provided a system, wherein determining the signature information includes determining a proposed set of security protocols that the entity has proposed for securing of communications of the entity.

In at least one embodiment, there is provided a system, wherein determining the behavior information corresponding to the entity includes: determining a behavior exhibited by the entity in the one or more messages; and determining the type of the entity includes analyzing the behavior.

In one embodiment, there is provided at least one non-transitory computer-readable storage medium having encoded thereon executable instructions that, when executed by at least one processor, cause the at least one processor to carry out a method, the method including: determining, at a server disposed in a content delivery network (CDN) and from one or more messages transmitted by an entity over the CDN, signature information and behavior information corresponding to the entity; determining a type of the entity at least in part by analyzing the signature information and behavior information corresponding to the entity; and outputting the type of the entity.

In additional embodiments, there is provided an at least one non-transitory computer-readable storage medium, wherein: the signature information includes fingerprint-based features of the entity gathered during authentication of the entity; and determining the signature information includes determining a proposed set of security protocols that the entity has proposed for securing of communications of the entity.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a system within which some embodiments may operate;

FIG. 2 is a flowchart of a method that may be implemented in some embodiments to identify an entity using signature and behavior information.

FIG. 3 is a flowchart of a method that may be implemented in some embodiments to identify an entity using signature and behavior information.

FIG. 4 is a flowchart of a process that may be implemented in some embodiments to identify an entity using signature information.

FIG. 5 illustrates an entity identification framework using machine learning techniques with which some embodiments may operate.

FIG. 6 illustrates an entity identification framework that may be implemented in some embodiments to train an entity identification classifier.

FIG. 7 is a block diagram of a computer system with which some embodiments may operate.

FIG. 8A illustrates experimental results from a known entity identification process identifying known entities according to some embodiments.

FIG. 8B illustrates experimental results from a known entity identification process identifying unknown or malicious entities according to some embodiments.

FIG. 9A illustrates experimental data showing the frequency of requests in a 24-hour period for different user-agents.

FIG. 9B illustrates experimental data showing the number of requests from mobile devices versus the number of requests from non-mobile entities in a 24-hour period.

FIG. 10A illustrates experimental data showing the distribution of JA3 hashes for a 24-hour period.

FIG. 10B illustrates experimental data showing the relationship between JA3 hashes and user-agents in a 24-hour period.

FIG. 11A illustrates experimental data showing the distribution of cipher suite lists for a 24-hour period.

FIG. 11B illustrates experimental data showing the distribution of cipher suites for a 24-hour period.

FIG. 11C illustrates experimental data showing the SSL cipher version distribution for a 24-hour period.

FIG. 12 is a flowchart of a method that may be implemented in some embodiments to identify an entity using signature and behavior information.

### DETAILED DESCRIPTION

Described herein are various embodiments of techniques for server-side entity identification, which may in some embodiments include techniques for identifying entities communicating in a network based on a signature for the entity and/or behavior of the entity as determined or observed by one or more servers in the network. In some embodiments, server-side identification may include signature analysis, including collecting information regarding the entity from communications received at the server and using such information to determine a signature of the entity. Such a server may be an intermediary server that may perform caching functionality and serve to clients content stored by one or more other servers on the network. In some embodiments, server-side identification can additionally or alternatively include behavior analysis, including current behaviors and historical behaviors gathered in part from network traffic transmitted by the entity, such as traffic between the entity and other devices on the network, such as the server doing the behavior analysis, other servers, or other devices.

Content providers and network operators face an ever-growing challenge in managing access of automated programs (e.g., “bots”) to their networks and communications of such automated programs via the networks. Some bots may conduct useful or necessary tasks, such as sending messages or reviewing web conduct to enable online searches (e.g., to add content to search engine databases). But others may be used for malicious or disruptive activities. Such malicious/disruptive activity could be attempting to penetrate security of devices on the network, swamping a device with traffic to prevent others from accessing it, or other activities. Generally, the former may be referred to as “good bots” while the latter may be referred to as “malicious” or “bad” bots.

Bad bots present a three-part threat to networks in general and CDNs in particular, namely, threats to the confidentiality of the information contained within such networks, the integrity of the network as a whole, and the availability of the network to its users. For example, bad bots can be used to scrape sensitive information from websites, launch distributed denial-of-service (DDoS) attacks, or spread spam and malware. Further, these bots can be used to create fake accounts or impersonate real users for malicious purposes (e.g., spreading misinformation or generating fake reviews).

Network operators have attempted to detect and mitigate bad bots with little success. Bad bot detection has been based on client-side determination of whether a user of that client or another entity that is communicating from that client is a human or a bot, including a bot that is malicious or trying to impersonate a legitimate entity. A bot that is trying to impersonate a legitimate entity may be referred to as a spoof bot and the entity may be referred to as a spoofed entity. For example, some websites employ CAPTCHA challenges or other challenge-response tests on the client side to determine whether a user is human or not. Other websites run algorithms within web browsers (i.e., on the client) to determine whether a purported user's interaction with the website is organic (e.g., by a human) or not.

The inventors have recognized and appreciated that client-side solutions can generate unwanted friction between users and the services they are attempting to access either by adding additional steps to the user authentication process or by increasing the computing burden on the user's device. Some techniques have been introduced to streamline usability and reduce this burden, but there can be a tension between reliability of the analysis and comprehensiveness of the analysis. The inventors have also recognized and appreciated that while conventional analyses have focused on increasing reliability of the analysis on the client's side, the client is able to access only some information regarding a communicating entity. Without access to that other information that is unavailable client-side, there are limitations to the reliability of an entity identification process.

Some embodiments described herein include server-side entity detection and identification. Some such techniques may leverage an entity's signature and/or behavior as determined by one or more servers on a network. In some embodiments, signature and behavior information can be gathered from network traffic data and internal server logs. In some embodiments, data collection and signature and/or behavior analysis can be performed by an end server communicating with the client, such as an origin server that hosts content (e.g., web content) to be served to clients in response to requests from the clients. The disclosure is not limited to operating with origin servers, as embodiments may operate with any other suitable server. For example, in some embodiments, such as in some CDNs, data collection and signature and/or behavior analysis may be performed by an intermediary server (e.g., a server in a CDN point of presence (POP)) between the client and the end server or by a server with access to the network traffic data and the internal logs of the end server. Such an intermediary server may perform caching functionality for the CDN, hosting content for one or more origin servers, which may in some cases include content that is requested by an entity for which analysis is being done.

In some embodiments, server-side identification can include identifying non-human entities as opposed to human entities, using machine learning algorithms leveraging at least the signature and behavioral features. In some embodiments, server-side identification can also include identifying good non-human entities as opposed to bad spoofed non-human entities through automated multiple-step verifications.

Server-side signature and behavior analysis may allow for increased detection accuracy and user satisfaction. For example, signature and behavior data received on the server-side includes information such as cypher suites, handshake protocols (e.g., TLS handshake protocols), and handshake behavior that cannot be readily gathered and analyzed client-side in the scale that may be needed or helpful for accurate prediction of the entity's identity. In addition, by removing client-side challenge-response tests, friction between legitimate users and clients as well as the computation burden on the user's device can be reduced.

An entity's signature may be or include a unique set of identifiers that can be used to identify an entity prior to and/or during the process of granting access to a network or other system. A signature may, in some embodiments, identify the entity in a manner that allows for distinguishing the entity from other entities communicating on the network, such as uniquely identifying the entity (including probabilistically uniquely identifying the entity) or allowing a recipient of communications to distinguish the entity from other entities for which communications are received. In some embodiments, a signature may enable a characterization of the entity, such as by being useful in determination of a type of the entity. For example, in some embodiments a signature may be used to determine whether an entity is a human, a bot, a good bot or a bad bot, or other determinations. According to some embodiments, an entity's signature may be characterized by fingerprint-based features gathered during an entity authentication process. In some embodiments, fingerprint-based features may include user-agent (UA) information, JA3 fingerprinting information, and cipher suite or security protocol information. In some embodiments, cipher suite or security protocol information may include cipher suite information negotiated during the handshake and the final signature algorithm chosen to encrypt data once the connection was established.

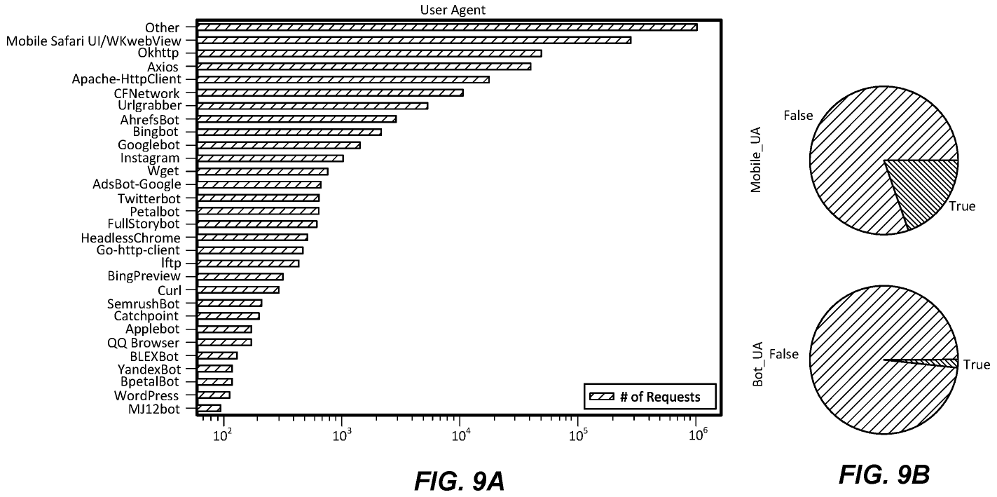

A user-agent (UA) may in some embodiments be or include software acting on behalf of a legitimate entity (e.g., a user). In some embodiments, user-agents can be referred to as clients. Some examples of user-agents include web browsers such as Safari and Chrome, as well as good bots such as Googlebot from Google® and Bingbot from Microsoft® Bing®. In some embodiments, user-agent information can include information regarding the end client a user interacts with in order to access content on a network. In some embodiments, user-agent information can include a string of text that a web browser or other client sends to a web server along with each request to identify itself and provide information about its capabilities. In some embodiments, user-agent information can be included as part of a request header sent by a client to a server. In some embodiments, user-agent information can include user-agent family information (e.g., type of browser and version information), type of user device implementing the client, operating system of the user device, and the like. FIG. 9A illustrates experimental data showing the frequency of requests in a 24-hour period for different UAs. FIG. 9B illustrates experimental data showing the number of requests from mobile devices versus the number of requests from non-mobile entities in a 24-hour period. It will be noted from FIG. 9B that for the tested 24-hour period 20% of all the traffic corresponded to mobile devices.

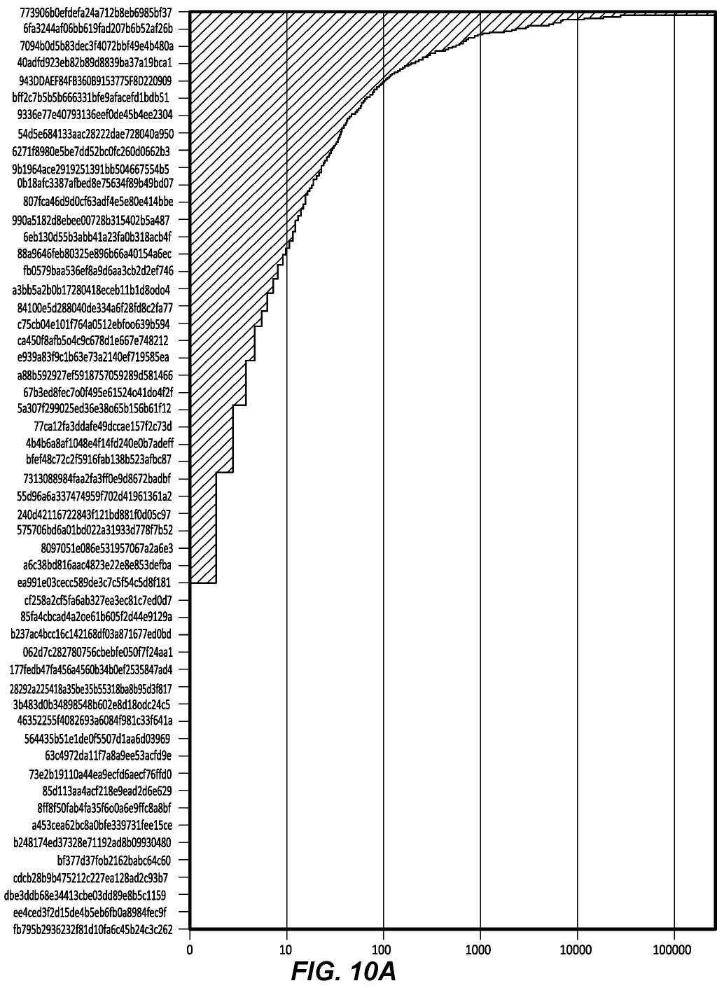

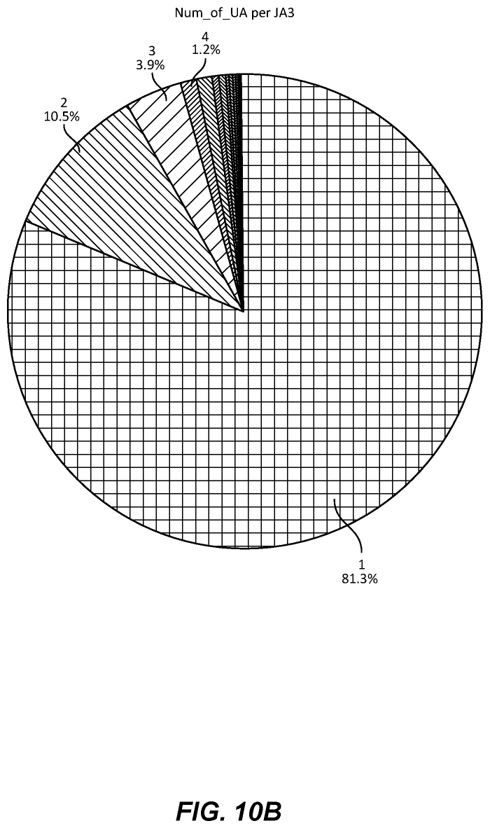

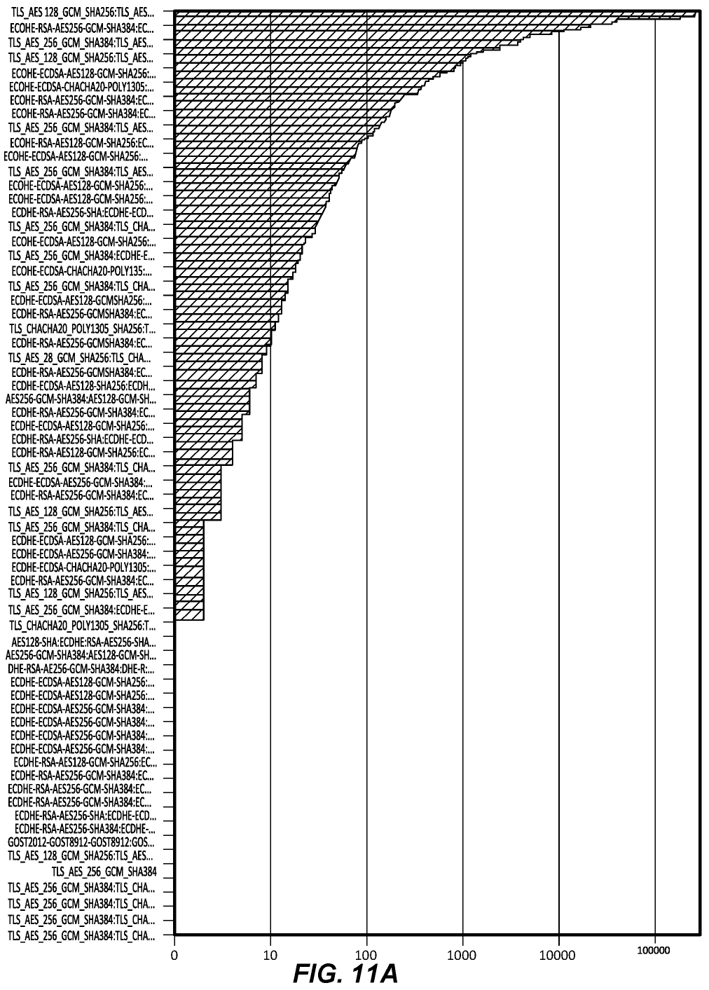

JA3 is a method of creating a fingerprint or hash (e.g., a unique fingerprint or hash) for a specific version of the Secure Sockets Layer (SSL) or Transport Layer Security (TLS) protocol used by a client or a server. These may be referred to herein as JA3 fingerprints, JA3 hash, JA3S fingerprints, JA3S hash, generically referred to herein (unless indicated otherwise) as JA3 fingerprints. In some embodiments, a JA3 fingerprint can be created by generating a hash of certain fields in the SSL or TLS client HELLO messages. In some embodiments, a JA3S fingerprint can be created by generating a hash of certain fields in the SSL or TLS server HELLO messages. In some embodiments, a JA3 fingerprint can include the supported cipher suites by the client and/or the client's random value. In some embodiments, JA3 fingerprinting information can include or be related to a JA3 fingerprint, UA information associated with the JA3 fingerprint, and an Internet Protocol (IP) addresses of the user devices implementing the client. In some embodiments, a given JA3 fingerprint can be related to a plurality of IP addresses but have the same type of UA. In some embodiments, the relationship between a JA3 fingerprint and any associated UAs or IP address can be indicative of a bad bot impersonating a legitimate client. FIG. 10A illustrates experimental data showing the distribution of JA3 hashes for a 24-hour period. In FIG. 10A each bar indicates the number of unique IPs for each JA3 in the logarithm domain. From the test data it can be noted that a small number of JA3 cover majority of traffic (e.g., top 10 JA3 cover 80% of total IPs and top 20 JA3 cover 90% of total IPs) and many JA3 only have very few IP addresses (e.g., 66% JA3 have 5 or fewer IPs and 50% JA3 have 2 or 1 IPs). FIG. 10B illustrates experimental data showing the relationship between JA3 hashes and user-agents in a 24-hour period. From the test data it can be noted that one unique JA3 can have many different IPs but the same type of UA. As shown in FIG. 10B, about 80% of JA3 only have 1 type of UA, and for JA3 having multiple UAs, sometimes UAs for the same JA3 may be similar (except for the version). Some UAs can look quite different for the same JA3 which can arise suspicion on the legitimacy of the entity.

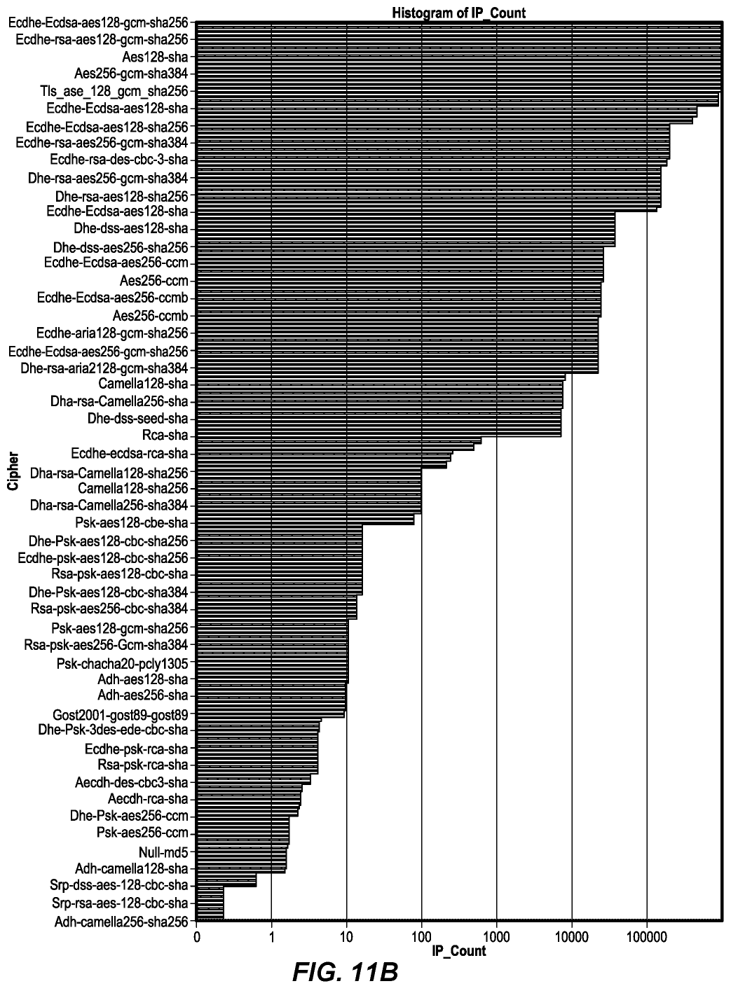

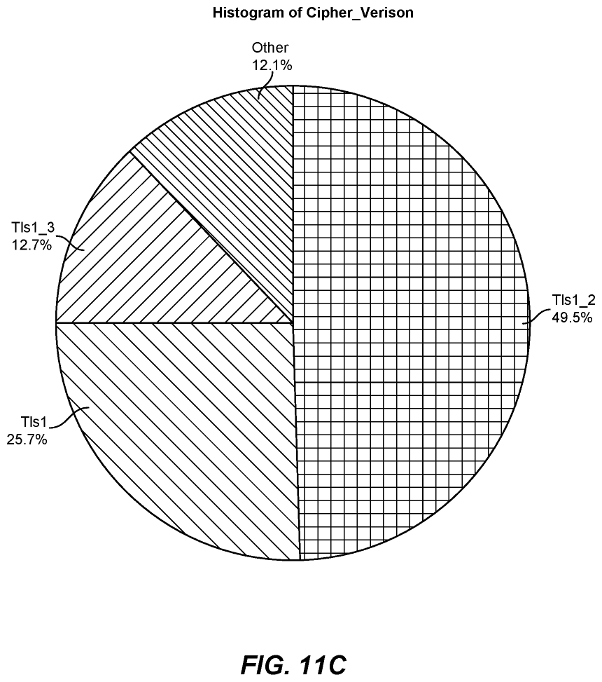

A cipher suite may be a set of techniques or security protocols that may be used to secure a network connection. In some embodiments, the set of techniques or protocols a cipher suite may contain may include: a key exchange algorithm, a bulk encryption algorithm, a message authentication code (MAC) algorithm, and other security techniques. In some embodiments, some or all of the elements in a network (e.g., a client and a server) maintain a cipher suite or security protocol list indicating the cipher suites supported by the element or application and that the element or application may use to communicate. Thus, a cipher suite or security protocol list may be a collection of cipher suites or security protocols that are supported by a particular client or server. In some embodiments, the cipher suites in a cipher suite list may be arranged in a specific order, with the most secure and preferred suites listed first. In some embodiments, when a client and server establish a secure connection, they negotiate which cipher or other security protocol to use by comparing the cipher suite lists (or security protocol lists) of supported ciphers for both entities and choosing one that is common to both cipher suites. The selection may be made, in some embodiments, according to the ranking or other information indicating preference. In some embodiments, entities that routinely choose weaker cypher protocols while purportedly supporting stronger cypher protocols can be considered potential bad bots. FIG. 11A and FIG. 11B illustrates experimental data showing the distribution of cipher suite lists and cipher suites, respectively, for a 24-hour period. From the test data it can be noted that the top 10 cipher suite lists cover 90% of total IPs and the top 15 cipher suites presented in 85%+ of IPs. FIG. 11C illustrates experimental data showing the SSL cipher version distribution for a 24-hour period. From the test data it can be noted that TLS 1.2 is the most extensively used version, making up 50% of traffic, followed by almost 26% for TLS 1.0. TLS 1.3, an upgraded version of TLS 1.2, makes up ˜13% of traffic.

An entity's behavior may be or include any activities or actions taken by an entity after it has been granted access to a network or a specific server forming part thereof. Behavior may be indicated from network traffic transmitted by the entity, including to one or multiple receiving entities (which may be the server doing entity identification or another entity) and including messages within one communication session or multiple communication sessions, including over a time period such as days, weeks, or months. Behavior over a time period may be referenced from data logs based on information identifying an entity, such as a signature or other identifier. In some embodiments, an entity's behavior can include historical violations or other transgressions of the entity on the server or network. According to some embodiments, an entity's behavior can be characterized by behavior-based features. In some embodiments, behavior-based features may include network traffic volume information (e.g., request counts, bytes in, backend bytes in, bytes out, backend bytes out, file size, etc.), timing and speed information (e.g., total connection times, total write times, inter arrival times, etc.), and entropy or cardinality of hosts, referrers, uniform resource locators (URLs), etc. (e.g., host, URL, referrer, content type). In some embodiments, behavior-based features can be gathered from access logs or HTTP headers.

Described below are illustrative embodiments of approaches for obtaining and analyzing signature and/or behavior information associated with an entity to identify whether the entity is a good bot, a bad bot, or human. It should be appreciated, however, that the embodiments described below are merely exemplary and that other embodiments are not limited to operating in accordance with the embodiments described below.

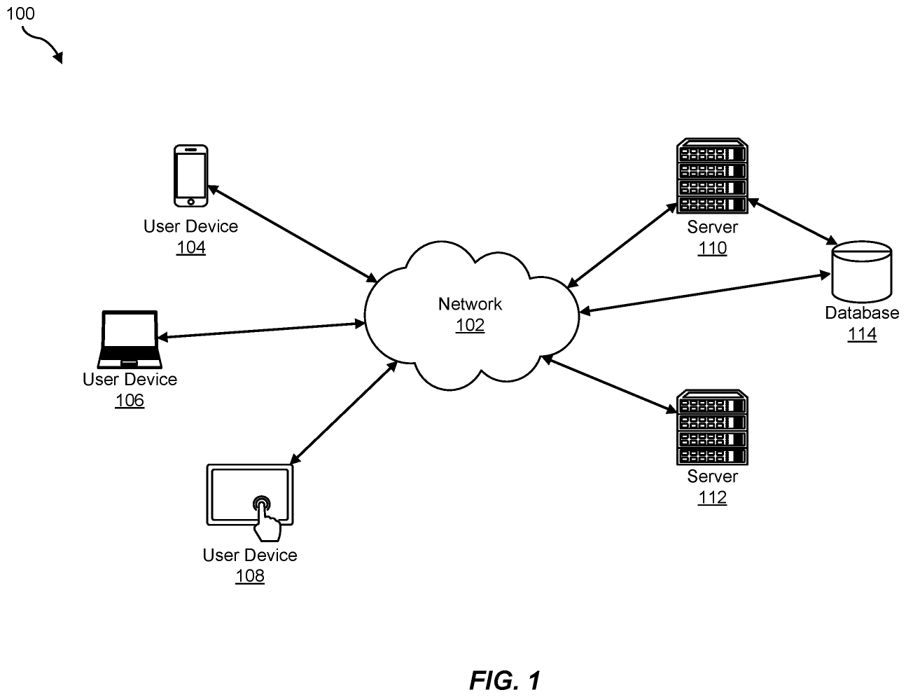

FIG. 1 illustrates a system 100 within which some embodiments may operate. Not all the components of system 100 may be required to practice the disclosure, and variations in the arrangement and type of the components may be made without departing from the spirit or scope of the disclosure.

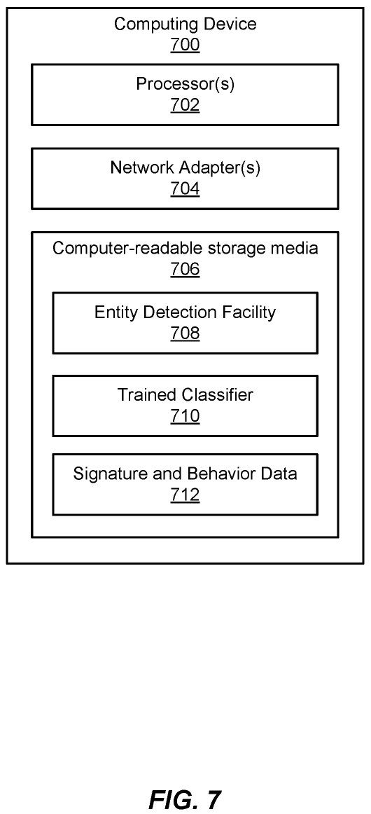

As shown, system 100 can include a network 102 and one or more user devices 104-108 communicatively coupled to one or more servers 110-112 via network 102. In some embodiments, database 114 may be communicatively coupled to server 110 and/or network 102. User devices 104-108 and/or servers 110-112 may be embodied on computing device 700 as discussed in relation to FIG. 7. Generally, however, user devices 104-108 can include virtually any portable computing device capable of receiving and sending a message over a network, such as network 102. In some embodiments, user device 104-108 can also be described generally as client devices that are configured to be portable.

In some embodiments, user device 104-108 can also include at least one client application that is configured to receive content from another computing device such as servers 110-112. In some embodiments, the client application can include a capability to request, receive, render, and display textual content, graphical content, audio content, and the like. In some embodiments, the client application can further provide information that identifies itself, including a type, capability, name, version, and the like. One example of a client application is a web browser.

Network 102 may be or include any one or more times of wired and/or wireless, local- and/or wide-area communication network(s), including one or more enterprise networks and/or the Internet. Embodiments are not limited to operating with any particular type of network.

In some embodiments, network 102 can include any of a variety of wireless sub-networks that may further overlay stand-alone ad-hoc networks, and the like, to provide an infrastructure-oriented connection for user device 104-108, servers 110-112, and/or database 114. Such sub networks can include mesh networks, Wireless LAN (WLAN) networks, cellular networks, and the like. In some embodiments, a wireless network may include virtually any type of wireless communication mechanism by which signals may be communicated between computing devices.

Network 102 may be or include any one or any combination of wired and/or wireless, local- and/or wide-area computer communication networks, and may include enterprise networks and/or the Internet. Network 102 may be enabled to employ any form of communication media for communicating information from one electronic device to another. Also, network 102 can include the Internet in addition to local area networks (LANs), wide area networks (WANs), or direct connections. According to some embodiments, a “network” should be understood to refer to a network that may couple devices so that communications may be exchanged (e.g., between a server and a client device) including between wireless devices coupled via a wireless network, for example. A network may also include mass storage or other forms of computer or machine-readable media, for example.

In some embodiments, network 102 can comprise a content distribution network(s). A “content delivery network” (sometimes referred to instead as a “content distribution network”) (CDN) generally refers to a distributed content delivery system that comprises a collection of computers, computing devices, and servers linked by a network or networks.

In some embodiments, servers 110-112 can further provide a variety of services that include, but are not limited to, email services, instant messaging (IM) services, streaming and/or downloading media services, search services, photo services, web services, social networking services, news services, third-party services, audio services, video services, mobile application services, or the like. Such services, for example can be provided via the servers 110-112, whereby a user is able to utilize such service upon the user being authenticated, verified or identified by the service. In some embodiments, servers 110-112 can store, obtain, retrieve, or provide user data corresponding to the users of user devices 104-108 or any other device on network 102, network traffic data for any device on network 102, internal logs of servers 110-112, or any other type of data that may be exchanged on network 102.

Servers 110-112 may be capable of sending or receiving signals, such as via a wired or wireless network, or may be capable of processing or storing signals, such as in memory as physical memory states. According to some embodiments, a “server” should be understood to refer to a service point which provides processing, database, and communication facilities. In some embodiments, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

Devices capable of operating as a server may include, as examples, dedicated rack-mounted servers, desktop computers, laptop computers, set top boxes, integrated devices combining various features, such as two or more features of the foregoing devices, or the like. In some embodiments, users are able to access services provided by servers 110-112 via the network 102 using their various devices 104-108.

In some embodiments, applications, such as, but not limited to, news applications (e.g., Yahoo! Sports®, ESPN®, Huffington Post®, CNN®, and the like), mail applications (e.g., Yahoo! Mail®, Gmail®, and the like), streaming video applications (e.g., YouTube®, Netflix®, Hulu®, iTunes®, Amazon Prime®, HBO Go®, and the like), instant messaging applications, blog, photo or social networking applications (e.g., Facebook®, Twitter®, Instagram®, and the like), search applications (e.g., Yahoo!® Search), and the like, can be hosted by servers 110 or other servers on network 102.

Thus, the server 110, for example, can store various types of applications and application related information including application data and user profile information (e.g., identifying and behavioral information associated with a user).

Moreover, although FIG. 1 illustrates servers 110 and 112 as single computing devices, respectively, the disclosure is not so limited. For example, one or more functions of servers 110-112 can be distributed across one or more distinct computing devices. Moreover, in one embodiment, servers 110 and/or 112 can be integrated into a single computing device, without departing from the scope of the present disclosure.

In some embodiments, server 110 may be configured to store and execute an entity identification facility that may operate in accordance with one or more techniques described herein to identify entities communicating via a network, such as to determine whether any entity may be a bot. In some embodiments, the entity identification facility may analyze communications transmitted by a device of the devices 104-108 to determine a type of an entity of a device (e.g., human users of or bots executing on the devices) that is transmitting such communications. The communications may be one or more messages sent by a device (of devices 104-108) to the server 112, such as to request content be provided by the server 112 to the device. The server 110 may intercept or observe such message(s). For example, in an embodiment in which the system 100 includes a CDN, the server 110 and database 114 may be a part of the CDN, such as part of a point of presence (POP) of the CDN. The server 110 (or an entity executing thereon) may receive the message(s) to determine whether and/or how to operate on the message, such as to determine whether a message requests content that is cached by the CDN and can be served by the CDN instead of being served by the server 112. In accordance with techniques described herein, in analyzing the message(s), the entity identification facility may determine signature and/or behavior information for an entity from the message(s) and, on that basis, determine a type of the entity. The signature and/or behavior identification may include analyzing messages transmitted contemporaneous with the analysis, such as messages that are received and for which an analysis is done before or in parallel with determining whether to operate on the message. The signature and/or behavior identification may additionally and/or alternatively include analyzing messages previously transmitted, such as over any suitable prior time period. Such information may be stored in database 114 and may be retrieved using an identifier for an entity, such as a signature for the entity determined by the entity identification facility.

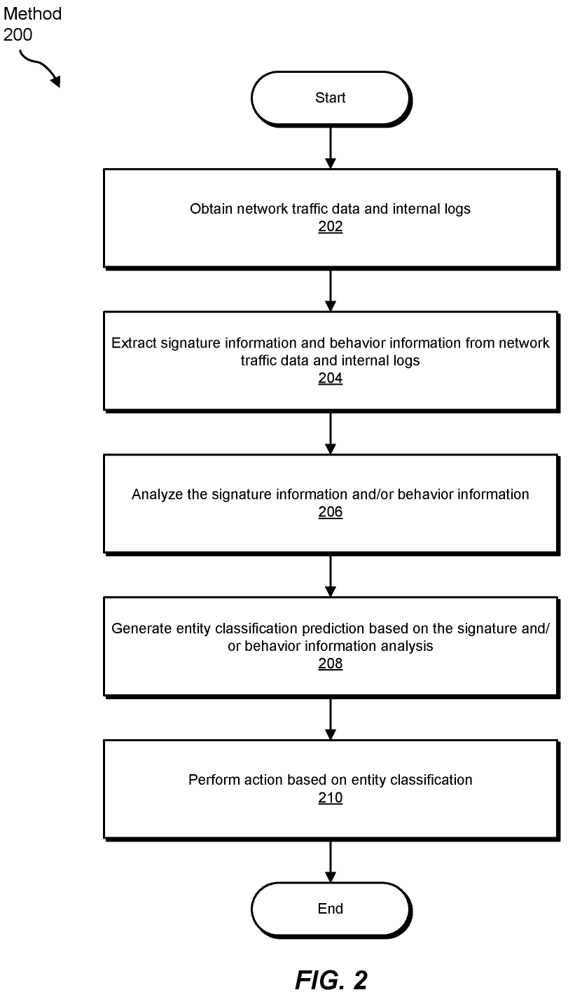

FIG. 2 is a flowchart of a method that may be implemented by an entity identification facility in some embodiments to identify an entity using signature and behavior information. Method 200 may be executed by an entity identification facility implemented on a server (e.g., server 110 or 112 discussed in relation to FIG. 1) or other computing device on a network (e.g., computing device 700 discussed in relation to FIG. 7).

In Step 202, the entity identification facility obtains network traffic data and logs. In some embodiments, the network traffic data and internal logs may correspond to communications transmitted by a client. In some embodiments, the client associated may be associated with an entity. In some embodiments, network traffic data and internal logs can correspond to one or more messages transmitted by the entity over the network.

In some embodiments, the network traffic data can be collected or gathered over a period of time. In some embodiments, the internal logs can be limited or windowed to the period of time. In some embodiments, the network traffic data and internal logs may be obtained by computing device (e.g., server 110) from a database (e.g., database 114) or from another device (e.g., by server 110 from server 112, or vice versa). The entity identification facility may retrieve communications for a past time from a database 114 using an identifier for a client and/or an entity, such as an IP address or other identifier, or using a signature calculated as in step 204 or otherwise as described herein.

In Step 204, the entity identification facility extracts or otherwise determines signature information and/or behavior information corresponding to the entity from the network traffic data and internal logs. As noted herein, in some embodiments, signature information can include user-agent (UA) information, JA3 fingerprinting information, and information exchanged in a security handshaking or negotiation process, such as a cipher suite or security protocol information. The cipher suite or security protocol information may include a list of security techniques (e.g., ciphers) that are proposed by an entity during a security handshaking or negotiation process as available to be used for securing communications with the entity. In some embodiments, behavior information can include network traffic volume information, timing and speed information, and entropy or cardinality of hosts, referrers, and/or URLs. Embodiments may calculate a signature based on this information in various ways. For example, a data structure combining each of these pieces of information may be used as a signature in some cases. As another example, a result of a calculation performed on the information may be additionally or alternatively used in other embodiments. For example, the signature information may be input to a hash function to generate a hash result, which may be additionally or alternatively included in the signature. In some embodiments that use multiple pieces of information for a signature, a signature may include some pieces of signature information without computation (e.g., raw values) and may include hash values or other calculated values for other pieces of signature information.

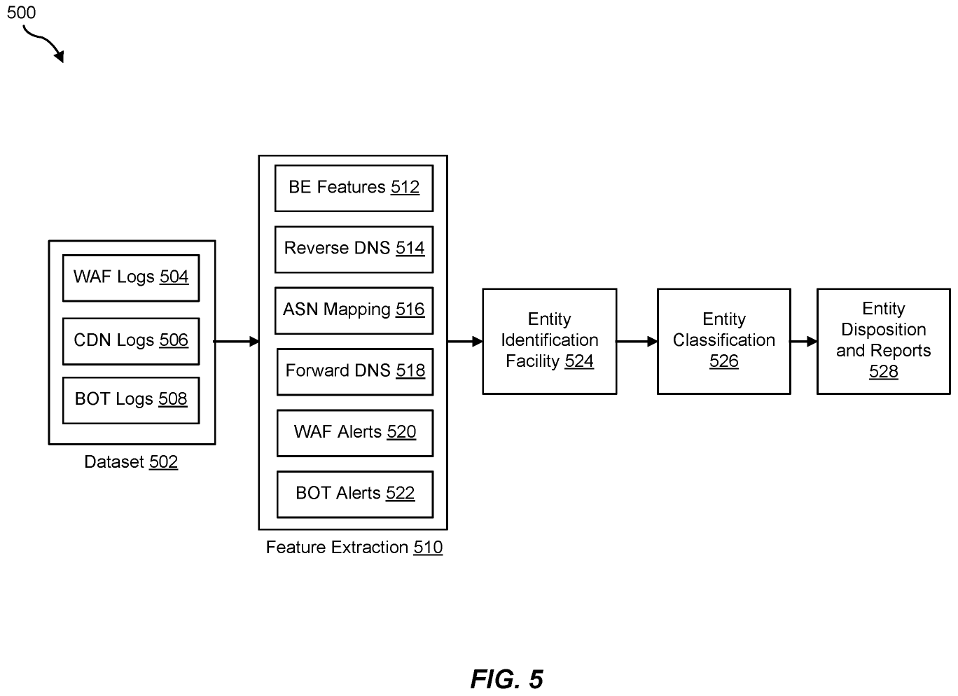

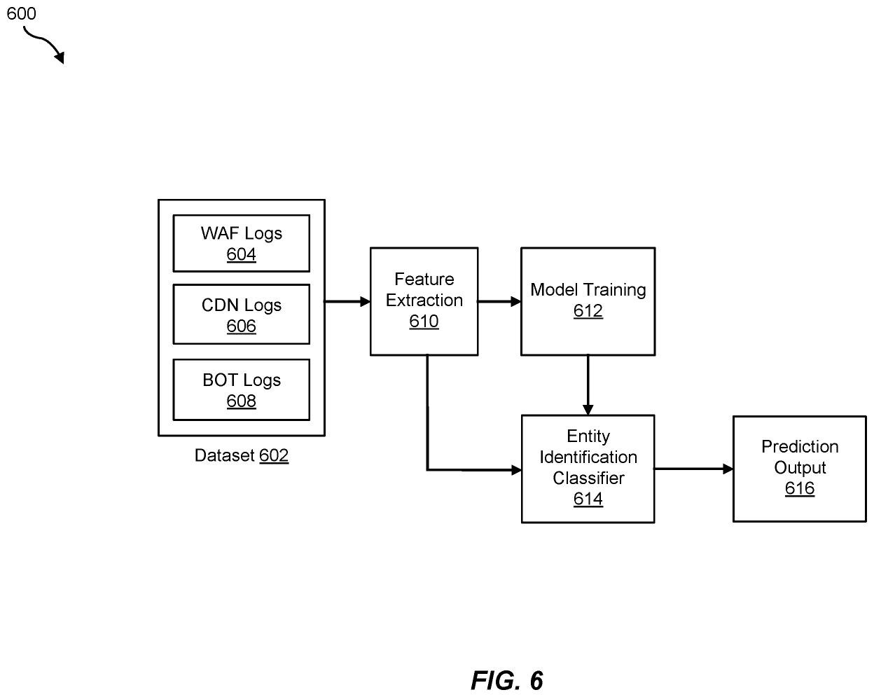

In Step 206, the entity identification facility analyzes the signature information and/or behavior information. In some embodiments, analyzing the signature information and/or behavior information can include a rules-based analysis technique. In some embodiments, analyzing the signature information and/or behavior information can include a machine learning analysis technique (e.g., as discussed in relation to FIG. 5 and FIG. 6).

In Step 208, the entity identification facility determines a type of the entity based at least in part in the analysis of the signature information and/or behavior information corresponding to the entity. In some embodiments, determining the type of entity can include generating and entity classification prediction based on the signature and/or behavior information analysis at Step 206.

In Step 210, the entity identification facility performs an action based on the entity classification at Step 208. In some embodiments, the action can be outputting the type of entity. In some embodiments, the action can include granting or denying the entity access to the network or terminating a connection with the entity. In some embodiments, the action can include notifying a third party of the entity classification.

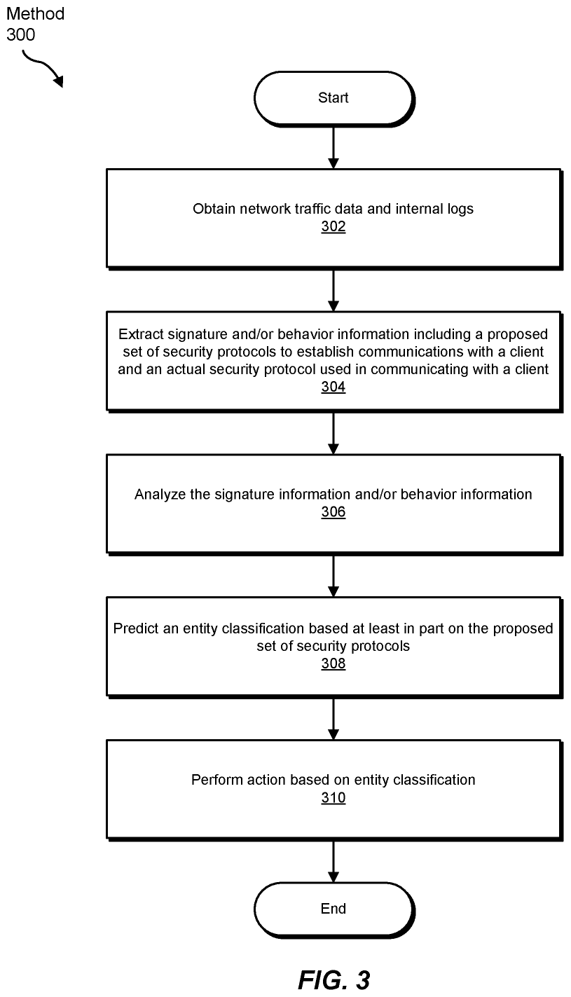

FIG. 3 is a flowchart of a method that may be implemented in some embodiments to identify an entity using signature and behavior information. Method 300 may be implemented by an entity identification facility executing on a server (e.g., server 110 or 112 discussed in relation to FIG. 1) or other computing device on a network (e.g., computing device 700 discussed in relation to FIG. 7).

In Step 302, the entity identification facility obtains network traffic data and logs. In some embodiments, the network traffic data and internal logs may correspond to communications transmitted by a client. In some embodiments, the client associated may be associated with an entity. In some embodiments, network traffic data and internal logs can correspond to one or more messages transmitted by the entity over the network.

In Step 304, the entity identification facility extracts or otherwise determines signature information and/or behavior information corresponding to the entity from the message(s) transmitted by the entity over the network. In some embodiments, the facility determines from the transmitted messages a proposed set of security protocols that the entity has proposed for securing of communications of the entity. In some embodiments, the facility may determine the security protocol selected for use in and/or used in securing the communications of the entity.

In Step 306, the entity identification facility analyzes the signature information and/or behavior information including the proposed set of security protocols. In some embodiments, analyzing the signature information and/or behavior information can include a rules-based analysis technique. In some embodiments, analyzing the signature information and/or behavior information can include a machine learning analysis technique (e.g., as discussed in relation to FIG. 5 and FIG. 6). In some embodiments, in Step 306, the identification facility determines from the message(s) transmitted by the entity over the network, a behavior exhibited by the entity in the message(s).

In Step 308, the entity identification facility determines a type of entity for the entity based at least in part in the analysis of the proposed set of security protocols and/or the exhibited behavior. In some embodiments, determining the type of entity can include generating and entity classification prediction based on the proposed set of security protocols and/or behavior analysis at Step 306.

In Step 310, the entity identification facility performs an action based on the entity classification at Step 308. In some embodiments, the action can be outputting the type of entity. In some embodiments, the facility may output an indication of whether the entity is a nonhuman entity.

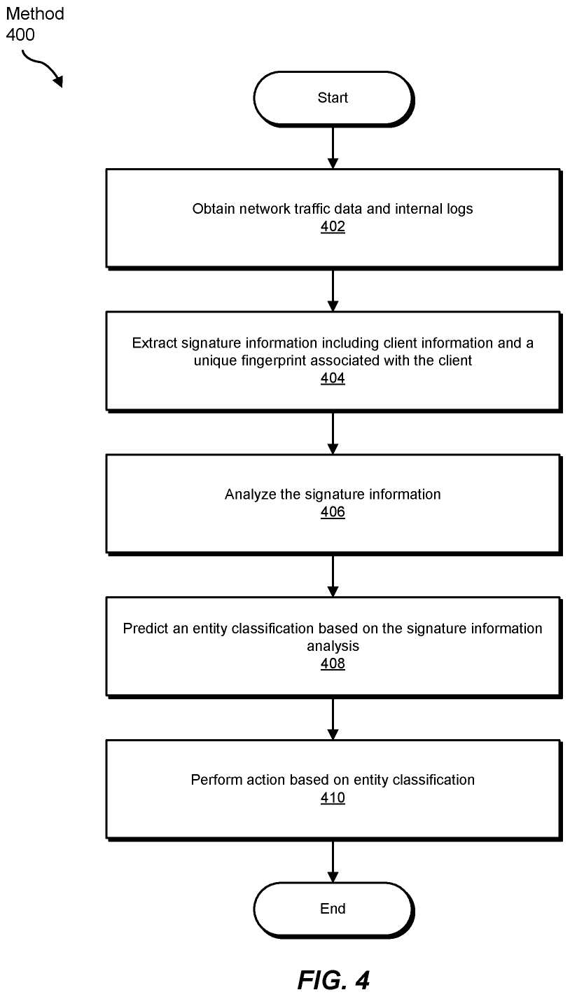

FIG. 4 is a flowchart of a method that may be implemented in some embodiments to identify an entity using signature and behavior information. Method 400 may be implemented by an entity identification facility executing on a server (e.g., server 110 or 112 discussed in relation to FIG. 1) or other computing device on a network (e.g., computing device 700 discussed in relation to FIG. 7).

In Step 402, the entity identification facility obtains network traffic data and logs. In some embodiments, the network traffic data and internal logs may correspond to communications transmitted by a client. In some embodiments, the client associated may be associated with an entity. In some embodiments, network traffic data and internal logs can correspond to one or more messages transmitted by the entity over the network.

In Step 404, the facility extracts or otherwise determines signature information including client information and a unique fingerprint (e.g., a JA3 fingerprinting information) associated with the client from the one or more messages transmitted by the entity over the network.

In Step 406, the facility analyzes the signature information including the client information and the unique fingerprint of the client. In some embodiments, analyzing the signature information can include a rules-based analysis technique. In some embodiments, analyzing the signature information can include a machine learning analysis technique (e.g., as discussed in relation to FIG. 5 and FIG. 6).

In Step 408, the entity identification facility determines a type of entity for the entity based at least in part in the analysis of the signature information and behavior information corresponding to the entity. In some embodiments, determining the type of entity can include generating and entity classification prediction based on the signature and/or behavior information analysis at Step 406.

In Step 410, the facility performs an action based on the entity classification at Step 408. In some embodiments, the action can be outputting the type of entity.

FIG. 5 illustrates an entity identification framework using machine learning techniques with which some embodiments may operate.

According to some embodiments, framework 500 can include receiving a dataset 502 including Web Application Firewall (WAF) logs 504, CDN logs 506, and bot logs 508. In some embodiments, WAF logs 504 can include information such as the source IP address, destination URL, request method (e.g., GET or POST), request headers, response code, and any blocking or filtering actions taken by the WAF. In some embodiments, CDN logs 506 can include information such as the client's IP address, the requested URL, the response status code, the bytes sent and received, the referrer, the user-agent, and any caching information.

In some embodiments, bot logs 508 can include IP address, the user-agent string, the requested URL, the response status code, the time of the request, among others.

In some embodiments, WAF logs 504, CDN logs 506, and BOT logs 508 are analyzed during a feature extraction process (e.g., Feature Extraction 510) to extract BE Features 512, a Reverse DNS 514, an ASN Mapping 516, a Forward DNS 518, WAF Alerts 520, and BOT Alerts 522. The features that are extracted may be the features for the dataset 502 that are most informative of entity type determination for entities to which the dataset 502 relates.

Then, in some embodiments, data for some or all of the extracted features is determined from one or more messages for an entity for which an entity identification is to be performed, and the extracted features for the entity are provided to an entity identification facility 524.

In some embodiments, the entity identification facility 524 can apply a predetermined set of rules derived from the dataset 502 to the extracted features to generate an entity classification 526. For example, the facility may determine whether the extracted features satisfy one or more rules. If so, the rules that are met or not met by the extracted features, or a result of an application of a rule (e.g., a value resulting from a calculation defined by a rule) are used to determine the entity classification, such as whether the entity is a human or a bot. In some cases, the determination of the classification may be based on whether all of the rules are met or whether more than a threshold number of the rules are met. In other cases, the determination may be based on an analysis of the rules that are met or not met or calculations defined by the rules. For example, a weighted calculation may be performed on results of rules, such as binary determinations of whether a rule is met or not or values resulting from analyses or calculations defined by rules. The analysis of the rules, including of the weights in embodiments that include weights, may lead to generation of a value that is evaluated to determine a type of an entity. For example, the value may be analyzed in connection with one or more thresholds. If a value for an entity satisfies a threshold, the entity may be determined to be of a particular type (e.g., bot).

In some embodiments, in addition to or as an alternative to a rules analysis, entity identification facility 524 can apply a machine learning model, trained based on the dataset 502, to the extracted features to generate entity classification 526. In some embodiments, the machine learning model can be a trained machine learning model as described in relation to FIG. 7. In some cases, the machine learning model may be a classifier that may output an identification of a class that the classifier predicts the entity may be in. In some cases, in which the model is a classifier, the model may output one or more predicted classes together with a confidence value for each class, where the confidence value indicates a confidence of the system that the entity would be correctly classified into the class, such as a confidence of the model that the entity would be correctly classified to be a human, a bot, or other entity type. In some cases, the classification associated with the top confidence value may be used as the classification of the entity. As another example, the confidences may be evaluated to determine whether any of the confidences exceed a threshold. If none of the classifications exceed the threshold, or if confidences for multiple classifications exceed the threshold, the facility may determine that the classification cannot be reliably determined, while if one classification exceeds the threshold the associated classification may be determined to be the classification of the entity. As another example, the confidences may be evaluated to determine whether any confidence level is more than a threshold amount higher than any other confidence, or the confidences may otherwise be compared to one another, to determine whether one confidence and associated classification may be identified as the classification of the entity. In this case, the classification associated with the selected confidence may be selected as the classification of the entity.

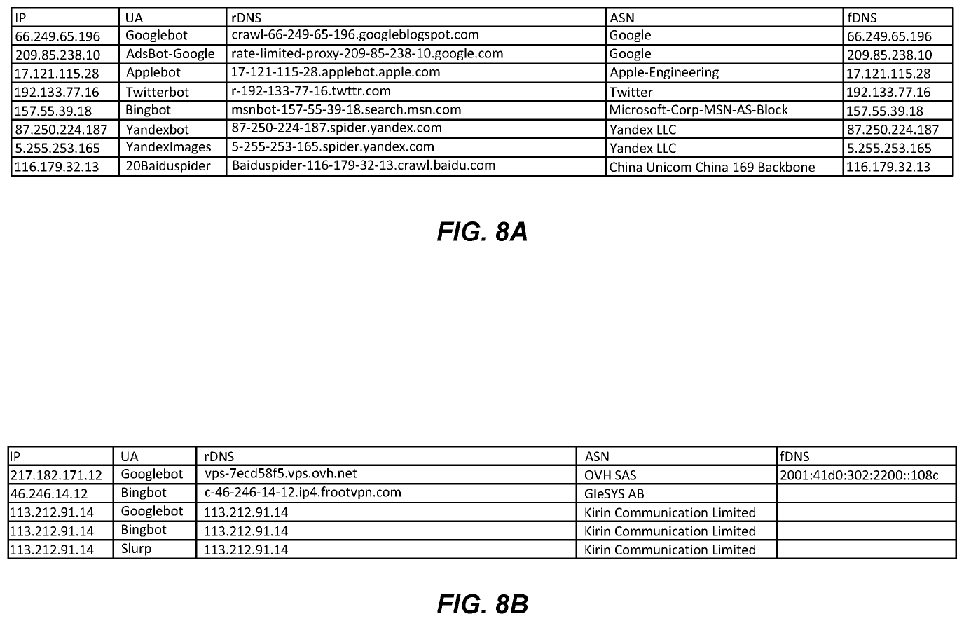

In some embodiments, entity identification facility 524 may perform a known entity identification and/or an unknown entity detection. During known entity identification, good entities may be identified and differentiated from spoofed entities that masquerade as good entities. According to an embodiment, to perform known entity identification, entity identification facility 524 may perform multiple-step verifications utilizing User Agents (UA), Reverse DNS lookup (e.g., Reverse DNS 514), ASN mapping (e.g., ASN Mapping 516), and forward DNS (e.g., Forward DNS 518). In some embodiments, during known entity identification an entity is identified as a known entity when a UA self-identifies as an entity (e.g., as a good bot such as Googlebot, Bingbot), an associated IP resolves to a legitimate DNS from Reverse DNS lookup, where Reverse DNS lookup returns the domain name for a given IP address; the DNS has matches with the UA and ASN mapping; and the forward DNS returns an IP the same as the original IP. Thus, in some embodiments, a legitimate known entity can be detected by matching, at least in part, IP domain information corresponding to the entity, such as a domain corresponding to an IP address as determined using the DNS system. Experimental data showing example results from known entity identification is illustrated in FIG. 8A and FIG. 8B. FIG. 8A illustrates experimental results from a known entity identification process identifying known entities. FIG. 8B illustrates experimental results from a known entity identification process identifying unknown or malicious entities. In some embodiments, known entity identification may include multi-factor verification based on analyzing a plurality of factors or features associated with an entity. For example, in an embodiment, entity identification facility 524 may check whether an entity self-identifies, whether an IP associated with the entity resolves to a legitimate DNS through a Reverse DNS lookup, whether a Reverse DNS lookup returns the correct domain name for a given IP address; whether the corresponding DNS has matches with the UA and ASN mapping; and whether the forward DNS returns an IP address matching the original IP address. In those embodiments, entity identification facility 524 may use one or more of the foregoing factors to identify or verify a known entity.

During unknown entity detection, entity identification facility 524 may propagate some of the extracted features from Feature Extraction 510 through a trained machine learning model (e.g., as described in relation to FIG. 6) to generate an entity classification prediction.

In some embodiments, entity identification facility 524 may output an entity classification 526 as discussed herein. Then, in some embodiments, based on the outputted entity classification 526, framework 500 may continue to determining an entity disposition based on the entity classification and/or generating and providing reports in entity disposition and reports 528. In some embodiments, an entity disposition can include serving browser challenges or blocking traffic.

FIG. 6 illustrates an entity identification framework that may be implemented in some embodiments to train a machine learning model for an entity identification classifier.

A machine learning model is a computational algorithm designed to perform a specific task by processing input data and generating output, where the precise manner in which it performs the task may change over the course of a training period and/or during use in performing the task over time as a result of the model (and/or a training process coupled with the model) determining how input data may correspond to different outputs. The model may not be explicitly programmed for the task it is performed, but may be adapted as a model to perform tasks like the task and then provided training data by which it determines how to perform the task. The model may operate by identifying patterns between inputs and outputs and making decisions or predictions of outputs based on input data. The model is “trained” through exposure to a dataset, wherein it learns and adapts its parameters for improved accuracy in its task. This training can follow various paradigms, as embodiments are not limited to any particular type of model training. Such training may include supervised learning, where the model learns from input-output pairs; unsupervised learning, where it discerns structures from unlabeled data; semi-supervised learning, which uses both labeled and unlabeled data; and reinforcement learning, where it learns through feedback from interactions with its environment. Machine learning models can vary in complexity from simple linear models to complex deep neural networks.

A classifier in the context of machine learning is a type of algorithm or model designed to categorize or classify input data into classes (which may be categories). It functions by analyzing input data and assigning it to one of the several classes based on its characteristics or features. The process involves training the classifier using a dataset where the class of each data point is known, allowing the model to learn and/or infer the distinguishing features of each class. Upon training, the classifier can then apply this learned relationship between input data and classes to new, unseen data to predict the appropriate class labels. Common types of classifiers include decision trees, support vector machines, neural networks, and Bayesian classifiers. Each type of classifier may have its own method of categorizing input data, ranging from simple rule-based approaches to complex, multi-layered computational processes. Hence, in some examples, an entity identification classifier may include a type of algorithm or model designed to categorize or classify entities into predefined classes or categories, such as, without limitation, human user, good bot, malicious bot, spoofed entity, unknown entity, compromised user, API client, network scanner, ad bot, content scraper, legitimate service bot, malicious human actor, and so forth.

According to some embodiments, framework 600 can include receiving a dataset 602 including WAF logs 604, CDN logs 606, and bot logs 608. In some embodiments, WAF logs 604, CDN logs 606, and bot logs 608 are analyzed during a feature extraction process at Feature extraction 610 to extract a plurality of features (similar to Feature Extraction 510 in framework 500). In some embodiments, dataset 602 can include a curated subset of thousands, millions, or billions of requests or messages per day, or any other suitable number of messages.

Then, in some embodiments, the extracted features and a set of labels for entities are provided for model training 612 to train entity identification classifier 614. The labeled entities for the training may be human, known bot, unknown bot, good bot, bad bot, and/or other labels. The labels may be used to define the classifications used by the classifier in embodiments that include the classifier. In some cases, a classifier may be configured through training with human/nonhuman, known/unknown bot, or with good/bad bot classes. In some embodiments, the output of a classifier (e.g., an entity identification facility as discussed herein) may be an indication or likelihood that an entity is a type of entity. For example, in some embodiments, the output of the entity identification facility is an indication of whether an entity is a malicious nonhuman entity and/or a likelihood, probability, or confidence that the entity is malicious and/or nonhuman. In some embodiments, model training 612 can include label generation, feature extraction, model preprocessing, model training, and model validation and evaluation. In some embodiments, entity identification classifier 614 can be any suitable machine learning model, including but not limited to Random Forest, AdaBoost, XGBoost, Support Vector Machines (SVM), Neural Networks (including Deep Neural Networks), Gradient Boosting Machines (GBM), Naive Bayes Classifiers, K-Nearest Neighbors (KNN), Logistic Regression, and Convolutional Neural Networks (CNNs), and so forth. In some embodiments, entity identification classifier 614 can be any suitable machine learning model capable of detecting and/or identifying entities, known or to be known, without departing from the present disclosure.

In some embodiments, once the entity identification classifier 614 has been trained it can be used during an inference process to predict a type of entity. In some embodiments, at inference time entity identification classifier 614 can receive extracted features from feature extraction 610, perform data preprocessing on the extracted features, and generate a prediction output 616. In some embodiments, prediction output 616 can include an entity score in a scale from 0.00 to 1.00. In those embodiments, the higher the score the more likely that the entity is a malicious or non-human entity. In some embodiments, the entity scores can be generated at different levels and the frequency of model training (e.g., model training 612) and model inferencing (e.g., prediction output 616) can vary.

In some embodiments, training of framework 600 can include a feedback loop to help improve false positives and false negatives. While in some embodiments, down-sampled data from dataset 602 can be used, in other embodiments, request data or data with higher sampling rates can be used. Higher sampling rates allow for the processing of billions of pieces of data to rapidly capture entity activities. In some embodiments, CDN logs (e.g., CDN logs 506 or CDN logs 606) for a 24-hour period can be down-sampled by a factor 1/1000 to be used in training.

Techniques operating according to the principles described herein may be implemented in any suitable manner. Included in the discussion above are a series of flow charts showing the steps and acts of various processes that determine whether a collision occurred and/or, if so, to characterize a collision. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of Steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 706 of FIG. 7 described below (i.e., as a portion of a computing device 700) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 1, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 7 is a block diagram of a computer system with which some embodiments may operate.

FIG. 7 illustrates one exemplary implementation of a computing device in the form of a computing device 700 that may be used in a system implementing techniques described herein, although others are possible. It should be appreciated that FIG. 7 is intended neither to be a depiction of necessary components for a computing device to operate a bot detection framework in accordance with the principles described herein, nor a comprehensive depiction.

Computing device 700 may comprise at least one processor 702, a network adapter 704, and computer-readable storage media 706. Computing device 700 may be, for example, a server, including a web server, a server of a content delivery network (CDN), including a point of presence (POP) of a CDN, a server of a cloud computing network or data center, or other suitable server. As another example, computing device 700 may be a desktop or laptop personal computer, a personal digital assistant (PDA), a smart mobile phone, or any other suitable computing device. Network adapter 704 may be any suitable hardware and/or software to enable the computing device 700 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable storage media 706 may be adapted to store data to be processed and/or instructions to be executed by processor 702. Processor 702 enables processing of data and execution of instructions. The data and instructions may be stored on the computer-readable storage media 706.

The data and instructions stored on computer-readable storage media 706 may comprise computer-executable instructions implementing techniques which operate according to the principles described herein. In the example of FIG. 7, computer-readable storage media 706 stores computer-executable instructions implementing various facilities and storing various information as described above. Computer-readable storage media 706 may store an entity identification facility 708, a trained classifier 710 for the entity identification facility 708 (including definitions of classes for the classifier), and data 712 that includes signature and behavior data, which may be collected for entity interactions and analyzed by the entity identification facility 708 and/or used to train the classifier 710 for subsequent use in analyzing data regarding a bot interaction.

While not illustrated in FIG. 7, a computing device 700 may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

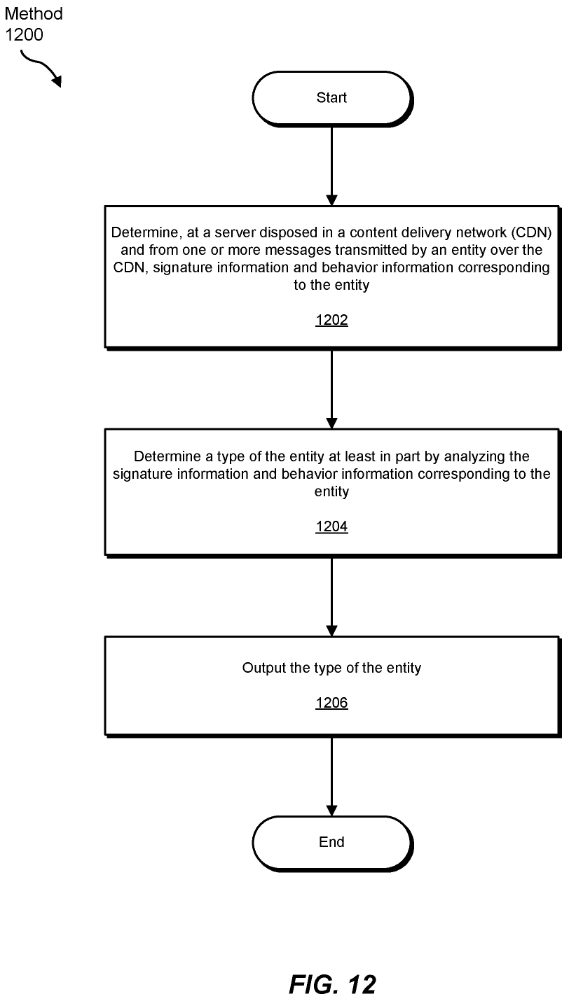

FIG. 12 is a flowchart of an example method for identifying an entity using signature and behavior information. The steps shown in FIG. 12 may be performed by any suitable computer-executable code and/or computing system, including server 110 or 112 in FIG. 1, computing device 700 in FIG. 7, and/or variations or combinations of one or more of the same. In some examples, the steps shown in FIG. 12 may be executed by an entity identification facility implemented on a server (e.g., server 110 or 112 discussed in relation to FIG. 1) or other computing device on a network (e.g., computing device 700 discussed in relation to FIG. 7). In at least one example, each of the steps shown in FIG. 12 may represent an algorithm whose structure includes and/or is represented by multiple sub-steps.

At step 1202, one or more of the systems or devices described herein may determine, at a server disposed in a CDN and from one or more messages transmitted by an entity over the CDN, signature information and behavior information corresponding to the entity. Step 1202 may be performed in any of the ways described herein.

At step 1204, one or more of the systems or devices described herein may determine a type of the entity at least in part by analyzing the signature information and behavior information corresponding to the entity. Step 1204 may be performed in any of the ways described herein.

At step 1206, one or more of the systems or devices described herein may output the type of the entity. Step 1206 may be performed in any of the ways described herein.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method comprising:
determining, at a server disposed in a content delivery network (CDN) and from one or more messages transmitted by an entity over the CDN, signature information and behavior information corresponding to the entity;
determining a type of the entity at least in part by analyzing the signature information and behavior information corresponding to the entity; and
outputting the type of the entity.

2. The method of claim 1, wherein the server comprises an intermediary server included in a CDN point of presence (POP) that caches content available at one or more origin servers that is to be provided by the intermediary server of the CDN POP to one or more clients.

3. The method of claim 1, wherein determining the signature information comprises determining fingerprint-based features of the entity gathered during authentication of the entity.

4. The method of claim 3, wherein the fingerprint-based features of the entity comprise at least one of:
user-agent (UA) information for the entity;
JA3 fingerprinting information for the entity;
cipher suite information for the entity; or
security protocol information proposed by the entity.

5. The method of claim 1, wherein determining the signature information comprises determining a proposed set of security protocols that the entity has proposed for securing of communications of the entity.

6. The method of claim 5, wherein:
determining the behavior information corresponding to the entity comprises determining a behavior exhibited by the entity in the one or more messages; and
determining the type of the entity comprises analyzing the behavior exhibited by the entity.

7. The method of claim 5, wherein:
determining the type of the entity comprises determining, based at least in part on analyzing the proposed set of security protocols, whether the entity communicating over the CDN is a nonhuman entity; and
outputting the type of the entity comprises outputting an indication of whether the entity has been determined to be a nonhuman entity.

8. The method of claim 1, wherein determining at least one of the signature information or the behavior information comprises analyzing log data corresponding to communications transmitted by the entity over the CDN.

9. The method of claim 1, wherein analyzing the signature information and behavior information comprises extracting one or more features from the one or more messages transmitted by the entity over the CDN, the one or more features comprising at least one of:
a Reverse Domain Name System (rDNS) result;
an Autonomous System Number (ASN) Mapping;
a Forward DNS result;
one or more Web Application Firewall (WAF) Alerts; or
one or more bot alerts.

10. The method of claim 9, wherein determining the type of the entity further comprises applying a predetermined set of rules to the one or more features to generate an entity classification.

11. The method of claim 1, wherein:
the method further comprises:
determining, from the one or more messages transmitted by the entity over the CDN, Internet Protocol (IP) domain information corresponding to the entity; and
determining whether the entity communicating over the CDN is a legitimate known entity by at least in part matching the IP domain information corresponding to the entity; and
outputting the type of the entity comprises outputting whether the entity is the legitimate known entity.

12. The method of claim 1, wherein determining the type of the entity comprises determining whether the entity communicating over the CDN is a malicious nonhuman entity at least in part by using at least one trained machine learning model that leverages the signature information and behavior information corresponding to the entity to generate an entity classification prediction; and
outputting the type of the entity further comprises outputting an indication of whether the entity is a malicious nonhuman entity.

13. The method of claim 12, wherein determining whether the entity communicating over the CDN is a malicious nonhuman entity at least in part by using the at least one trained machine learning model that leverages the signature information and behavior information corresponding to the entity to generate the entity classification prediction comprises processing extracted features via the at least one trained machine learning model trained to generate the entity classification prediction.

14. The method of claim 13, wherein:
the entity classification prediction comprises a classification of the entity with a confidence value; and
outputting the type of the entity further comprises outputting the confidence value.

15. A system comprising:
at least one processor; and
at least one computer-readable medium having encoded thereon executable instructions that, when executed by the at least one processor, cause the at least one processor to carry out a method, the method comprising:
determining, at a server disposed in a content delivery network (CDN) and from one or more messages transmitted by an entity over the CDN, signature information and behavior information corresponding to the entity;
determining a type of the entity at least in part by analyzing the signature information and behavior information corresponding to the entity; and
outputting the type of the entity.

16. The system of claim 15, wherein the signature information comprises fingerprint-based features of the entity gathered during authentication of the entity.

17. The system of claim 15, wherein determining the signature information comprises determining a proposed set of security protocols that the entity has proposed for securing of communications of the entity.

18. The system of claim 17, wherein determining the behavior information corresponding to the entity comprises:
determining a behavior exhibited by the entity in the one or more messages; and
determining the type of the entity comprises analyzing the behavior.

19. At least one non-transitory computer-readable storage medium having encoded thereon executable instructions that, when executed by at least one processor, cause the at least one processor to carry out a method, the method comprising:
determining, at a server disposed in a content delivery network (CDN) and from one or more messages transmitted by an entity over the CDN, signature information and behavior information corresponding to the entity;
determining a type of the entity at least in part by analyzing the signature information and behavior information corresponding to the entity; and
outputting the type of the entity.

20. The at least one non-transitory computer-readable storage medium of claim 19, wherein:
the signature information comprises fingerprint-based features of the entity gathered during authentication of the entity; and
determining the signature information comprises determining a proposed set of security protocols that the entity has proposed for securing of communications of the entity.
